(19) United States
(12) Patent Application Publication
(10) Pub. No.: US 2017/0371713 A1
(43) Pub. Date: Dec. 28, 2017

(54) INTELLIGENT RESOURCE MANAGEMENT SYSTEM

(71) Applicant: Sidra Medical and Research Center, Doha (QA)

(72) Inventors: Nagarajan Kathiresan, Doha (QA); Rashid Al-Ali, Doha (QA)

(21) Appl. No.: 15/194,052

(22) Filed: Jun. 27, 2016

(51) Int. Cl. G06F 9/50

(52) U.S. Cl. CPC G06F 9/5027

(57) ABSTRACT

The specification relates to an intelligent resource management system. The system is capable of receiving a job script file requesting to run analyses for a data file on a multi-CPU system using a multi-threaded application. The system then builds an application knowledge structure and an intelligent resource mapping table based on the application knowledge structure with the intelligent resource mapping table requesting a number of CPUs needed for the analysis. The data file can be partitioned into a number of data segments equaling to the number of CPUs needed for the analysis and a number of application instances equal to the number of CPUs needed for the analysis can be created. The multi-threaded applications are executed on a plurality of CPUs for each bio-informatics data segment and resultants are obtained for each execution. These resultants are combined in the same order of data partitioning to obtain analysis.

### BACKGROUND

The subject matter described herein relates to an intelligent resource management system for managing multi-CPU architecture.

Multi-CPU architecture can be described as a cluster of independent computers combined into a unified system through software and networking. Multi-CPU architecture can include independent CPUs connected by high-speed networks and middleware to create a single system. When two or more computers are used together to analyze data or solve a problem, it is considered to be a cluster. Clusters are typically used for High Performance Computing (HPC) and provide greater computational power than a single CPU architecture can provide.

Many conventional multi-CPU architectures typically include a resource management system (RMS). The RMS provides an interface for user-level sequential and parallel applications to be executed on the multi-CPU architecture. The RMS also provides support of four main functionalities: management of resources; job queuing; job scheduling; and job execution.

HPC systems have become more popular and commonly available to address complex scientific problems. In order to solve these complex scientific problems, the HPC system must be able to access large memory banks and a number of processors in order to analyze the high volume of information contained in input files and other data resources. For example, most DNA sequence alignment applications are dominated by high memory, input/output and computation needs and hence bioinformatics scientists prefer to run sequence alignment applications in an HPC environment to obtain faster results.

An HPC environment can have multi-CPU nodes having multiple cores within the CPUs, shared/private caches, non-uniform memory access (NUMA) and other characteristics. As shown in FIG. 1, these HPC systems 200 are shared across multiple users through batch processing systems or schedulers to execute their sequential, parallel or distributed applications and are referred to as workload management systems (WMS). As HPC clusters grow in size, they become increasingly complex and time-consuming to manage. Typical workload management systems have: (i) limitations with respect to thread scalability, (ii) performance penalties in remote memory access for NUMA-based architecture and (iii) limitations in the shared/private cache of the CPUs. For example, FIG. 1 shows a conventional HPC environment with an imbalance (represented by a dark color when it's heavily utilized, represented by a light color when it's slightly utilized) in main memory and cache memory access across the multiple CPUs (CPU1, CPU2, CPU3, CPU4) when large data files are being analyzed by a single application process (represented by a solid circle) with 16 threads (each thread represented by ˜). The 16 threads are not equally distributed across multiple CPUs, as demonstrated by the unevenly distributed tildes, due to the absence of a resource mapping table or task affinity was not set in the scheduling.

Typical workload management systems also lack intelligence beyond scheduling user job submissions. As a result, application execution times are negatively impacted due to inefficient and sub-optimal usage of HPC resources thereby affecting the quality of service.

### SUMMARY

The disclosed technology improves the application performance of high-performance computing without using traditional multi-step performance engineering concepts. The disclosed technology manages tasks such as deployment, maintenance, scheduling and monitoring of multi-CPU architecture systems using an Intelligent Resource Management System (IRMS). The IRMS has three functional components that can be added into a traditional RMS: (1) an Application Knowledge Structure that can be added to or part of a job scheduler, (2) an Intelligent Resource Mapping Table that can be added to or part of job manager and (3) a Resource Management Table that can be added to or part of a resource status manager. As shown in FIG. 2, the IRMS of the disclosed technology creates uniform cache/main memory access across the multiple CPUs 300 (CPU1, CPU2, CPU3, CPU4). The disclosed IRMS can perform analyses, (e.g., bio-informatics), using a hybrid model of dynamically combining data-parallelization, multi-processing (represented by a solid circle across 4 CPUs and the solid circles each representing four instances of the application), and multi-threading (represented by and the threads are equally distributed to each core of the CPUs) at runtime based on hardware selections of the job scheduler, i.e., a single application, a single data file with 16 threads are scheduled as four instances of an application with four disjoint data segments and four threads per application instance.

In one implementation, the methods comprise the steps of: receiving a job script file, the job script file requesting to run a bio-informatics analysis for a bio-informatics data file on a multi-CPU system using a multi-threaded bio-informatics application; building an application knowledge structure for the multi-threaded bio-informatics application using the job script file and known application arguments, the application knowledge structure having a dynamic and disjoint set of arguments that can be independently executable at each CPU of the multi-CPU system; building an intelligent resource mapping table based on the application knowledge structure, the intelligent resource mapping table requesting a number of CPUs needed for the bio-informatics analysis; partitioning the bio-informatics data file into a number of bio-informatics data segments equaling to the number of CPUs needed for the bio-informatics analysis; creating a number of application instances equal to the number of CPUs needed for the bio-informatics analysis; designating a plurality of CPUs from the multi-CPU system so that each CPU of the plurality of CPUs receives one application instance of the number of application instances and one bio-informatics data segment of the number of bio-informatics data segments, the plurality of CPUs equaling the number of CPUs needed for the bio-informatics analysis; executing the multi-threaded bio-informatics applications for each bio-informatics data segment on each CPU of the plurality of CPUs, wherein a bio-informatics multi-process is executed for each bio-informatics data segment within a number of CPU cores associated with each CPU of the plurality of CPUs; obtaining resultants for each execution of the multi-process on each CPU of the plurality of CPUs; and combining the resultants in the same order of data partitioning to obtain the bio-informatics analysis.

In some implementations, the executing step can use a hybrid model of data-parallel, multi-process and multi-threads and this can be dynamically implemented at runtime to improve application performance.

In some implementations, the bio-informatics application can run as multi-threads equaling a number of cores for each CPU running different bio-informatics data segments. In some implementations, the method can separate the job script file into application information and resource information.

In some implementations, the method can validate application required resource information against the hardware resource requested information of the job script file; and if the application required resource information matches with the hardware resource requested information of the job script file, identify the hardware resources associated with the multi-CPU system for scheduling the request. In some implementations, hardware topology details can be collected from the intelligent resource management table.

In some implementations, the bio-informatics analysis is a sequence alignment. In some implementations, the bio-informatics data file is a sequence alignment file. In some implementations, the bio-informatics data segments approximately equal a size of the bio-informatics data file divided by the number of CPUs needed for the bio-informatics analysis. In some implementations, the application information includes application name, reference data, input files and number of threads to run.

In another implementation, a system can comprise one or more processors and one or more computer-readable storage mediums containing instructions configured to cause the one or more processors to perform operations. The operations can include: receiving a job script file, the job script file requesting to run a bio-informatics analysis for a bio-informatics data file on a multi-CPU system using a multi-threaded bio-informatics application; building an application knowledge structure for the multi-threaded bio-informatics application using the job script file and known application arguments, the application knowledge structure having a dynamic and disjoint set of arguments that can be independently executable at each CPU of the multi-CPU system; building an intelligent resource mapping table based on the application knowledge structure, the intelligent resource mapping table requesting a number of CPUs needed for the bio-informatics analysis; partitioning the bio-informatics data file into a number of bio-informatics data segments equaling to the number of CPUs needed for the bio-informatics analysis; creating a number of application instances equal to the number of CPUs needed for the bio-informatics analysis; designating a plurality of CPUs from the multi-CPU system so that each CPU of the plurality of CPUs receives one application instance of the number of application instances and one bio-informatics data segment of the number of bio-informatics data segments, the plurality of CPUs equaling the number of CPUs needed for the bio-informatics analysis; executing the multi-threaded bio-informatics applications for each bio-informatics data segment on each CPU of the plurality of CPUs, wherein the bio-informatics multi-process for each bio-informatics data segment is executed within a number of CPU cores associated with each CPU of the plurality of CPUs; obtaining resultants for each execution of the multi-process on each CPU of the plurality of CPUs; and combining the resultants in the same order of data partitioning to obtain the bio-informatics analysis.

In another implementation, a system comprising: a processor that receives a job script file, the job script file requesting to run an analysis for a data file on a multi-CPU system using a multi-threaded application; a processor that builds an application knowledge structure for the multi-threaded application from the job script file and known application arguments, the application knowledge structure having a dynamic and disjoint set of arguments that can be independently executable at each CPU of the multi-CPU system; a processor that builds an intelligent resource mapping table based on the application knowledge structure, the intelligent resource mapping table requesting a number of CPUs needed for the analysis; a processor that partitions the data file into a number of data segments equaling to the number of CPUs needed for the analysis; a processor that creates a number of application instances equal to the number of CPUs needed for the analysis; a processor that designates a plurality of CPUs from the multi-CPU system so that each CPU of the plurality of CPUs receives one application instance of the number of application instances and one data segment of the number of data segments, the plurality of CPUs equaling the number of CPUs needed for the analysis; a processor that executes the multi-threaded applications for each data segment on each CPU of the plurality of CPUs, wherein a multi-process is executed for each data segment within a number of CPU cores associated with each CPU of the plurality of CPUs; and a processor that obtains resultants for each execution of the multi-process on each CPU of the plurality of CPUs.

In another implementation, a system comprising: a processor that receives a job script file, the job script file requesting to run an analysis for a data file on a multi-CPU system using a multi-threaded application; the processor builds an application knowledge structure for the multi-threaded application from the job script file and known application arguments, the application knowledge structure having a dynamic and disjoint set of arguments that can be independently executable at each CPU of the multi-CPU system; the processor builds an intelligent resource mapping table based on the application knowledge structure, the intelligent resource mapping table requesting a number of CPUs needed for the analysis; the processor partitions the data file into a number of data segments equaling to the number of CPUs needed for the analysis; the processor creates a number of application instances equal to the number of CPUs needed for the analysis; the processor designates a plurality of CPUs from the multi-CPU system so that each CPU of the plurality of CPUs receives one application instance of the number of application instances and one data segment of the number of data segments, the plurality of CPUs equaling the number of CPUs needed for the analysis; the processor executes the multi-threaded applications for each data segment on each CPU of the plurality of CPUs, wherein a multi-process is executed for each data segment within a number of CPU cores associated with each CPU of the plurality of CPUs; and the processor obtains resultants for each execution of the multi-process on each CPU of the plurality of CPUs.

In another implementation, a resource manager run on a multi-CPU system using a multi-threaded application comprising: an application knowledge structure, stored in a non-transitory medium, having a dynamic and disjoint set of arguments that can be independently executable at each CPU of the multi-CPU system, the application knowledge structure being built from a job script file requesting to run an analysis for a data file and known application arguments for the multi-threaded application; an intelligent resource mapping table, stored in a non-transitory medium, requesting a number of CPUs needed for the analysis, the intelligent resource mapping table being built based on the application knowledge structure; and a processor that partitions the data file into a number data segments equaling to the number of CPUs needed for the analysis, creates a number of application instances equal to the number of CPUs needed for the analysis, designates a plurality of CPUs from the multi-CPU system so that each CPU of the plurality of CPUs receives one application instance of the number of application instances and one data segment of the number of data segments, the plurality of CPUs equaling the number of CPUs needed for the analysis, executes the multi-threaded applications for each data segment on each CPU of the plurality of CPUs, wherein a multi-process is executed for each data segment within a number of CPU cores associated with each CPU of the plurality of CPUs and obtains resultants for each execution of the multi-process on each CPU of the plurality of CPUs.

Advantages of the disclosed technology is that the technology (1) uses architecture intelligence for better performance of CPUs and software at runtime, (2) automates various steps in distributing work amongst the CPUs, e.g. partitioning of a data file into data segments, creating multiple instances of the application, running multiple threads within every instance of the application with disjoint set of data segments based on the architecture selected by the job manager/job scheduler before job submission, (3) dynamically performs these steps at runtime at the job scheduler without manual interaction, (4) provides a uniform resource allocation that eliminates remote memory access and (5) minimizes cache misses.

### BRIEF DESCRIPTION OF THE DRAWINGS

FIG. 1 is a pictorial diagram of conventional resource utilization in a multi-CPU architecture;

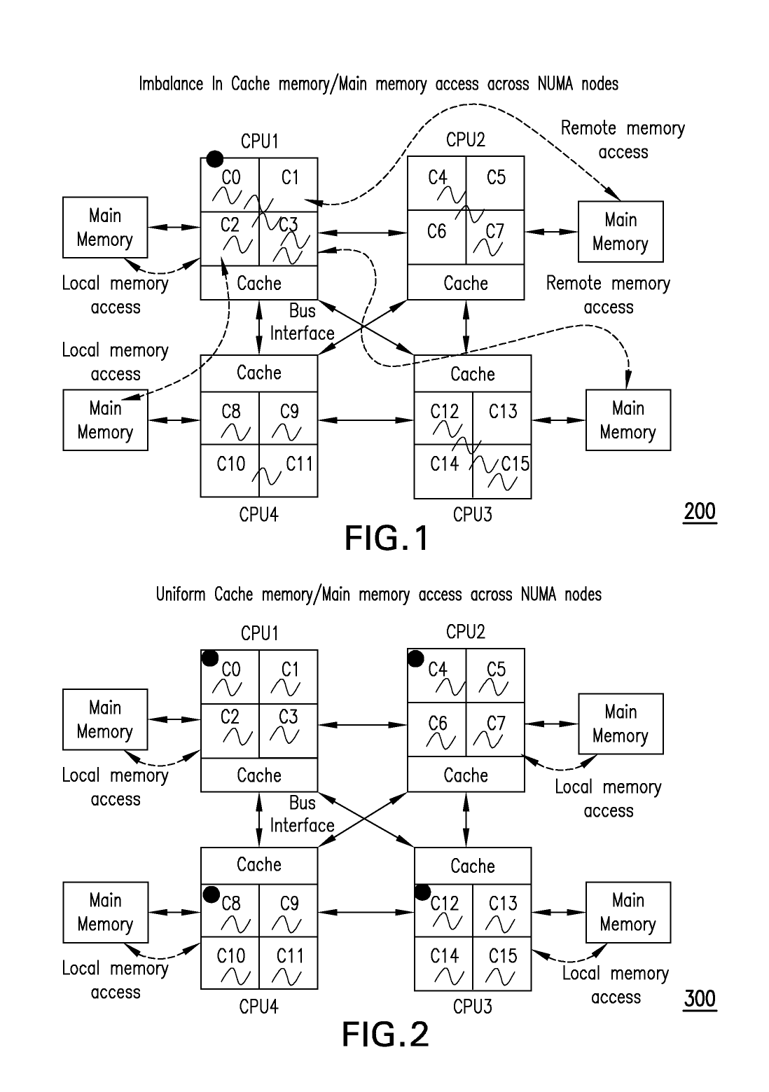

FIG. 2 is a pictorial diagram of resource utilization in a multi-CPU architecture system used in accordance with the disclosed technology;

FIG. 3 is a pictorial diagram of conventional multi-CPU architecture;

FIG. 4 is a block diagram of conventional architecture of Resource Management System;

FIG. 5 is a block diagram of Intelligent Resource Management system used in accordance with the disclosed technology;

FIGS. 6A-B are a flow chart showing an example process of the disclosed technology;

FIG. 7 is a flow chart showing an example process of the disclosed technology;

FIG. 8 is a table showing results of examples of the disclosed technology using 4 CPUs, 8 cores per CPU server;

FIG. 9 is an experimental illustration of Test #1, Test #2, Test #3 and Test #4 of FIG. 8 using the disclosed technology;

FIG. 10 is a table showing results of examples of the disclosed technology using 8 CPUs, 8 cores per CPU server; and

FIG. 11 is a block diagram of an example of a system used with the disclosed technology.

### DETAILED DESCRIPTION

The IRMS of the disclosed technology can be used to perform complex analyses, e.g., bio-informatics, using a hybrid model of dynamically combining data-parallelization, multi-processing and multi-threading techniques at runtime based on the hardware selection of the job scheduler.

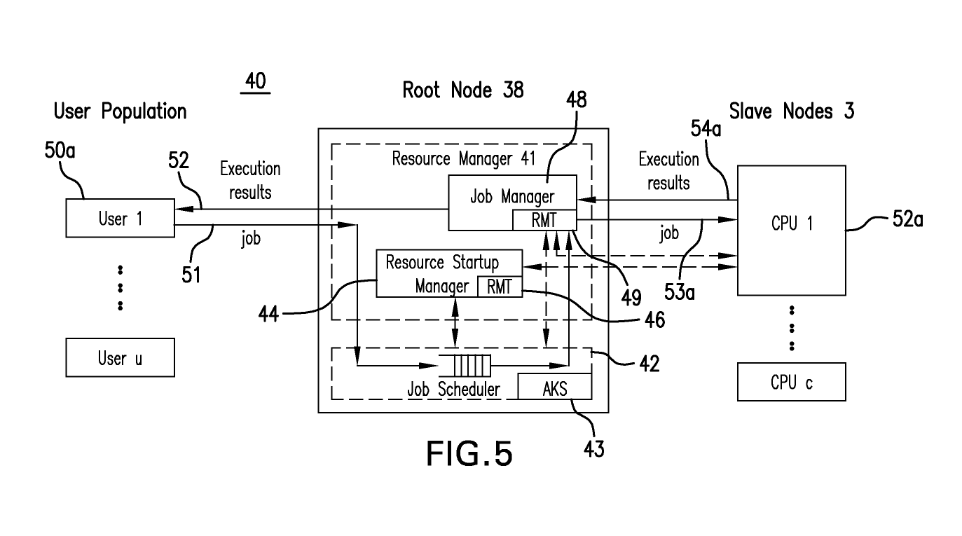

As shown in FIG. 3, a cluster 10 can be a collection of computers 12, 14, 16, 18 working together as a single, integrated computing resource. The cluster includes a root node 12 with a number of slave nodes 14, 16, 18. Clusters can be, but are not always, connected through local area networks. Clusters can be usually deployed to improve speed or reliability over that provided by a single computer, while being more cost-effective than single computers of comparable speed or reliability.

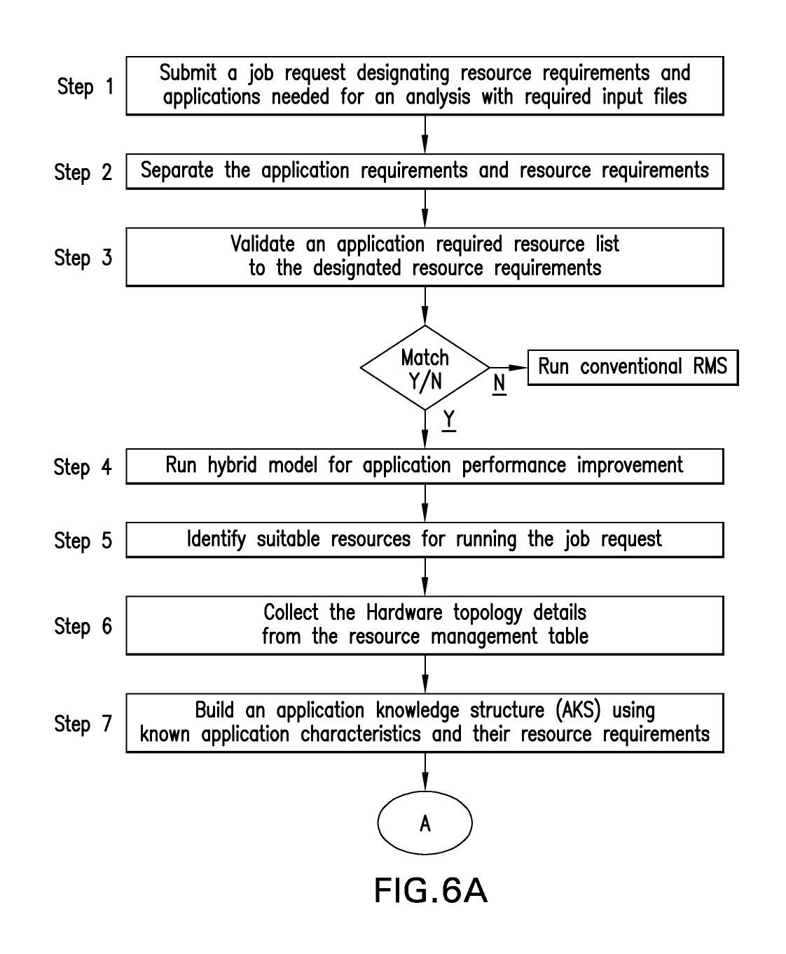

The conventional architecture 20 of interaction of nodes is shown in FIG. 4. This conventional architecture 20 includes a root node 22 having an installed Resource Management System 24. The Resource Management System 24 manages a processing load by preventing jobs submitted by users 34a, . . . , from competing with each other for limited computer resources and enables effective and efficient utilization of resources available. The Resource Management System can include: (1) a job scheduler 30, (2) a job manager 26 and (3) a resource status manager 28.

The job scheduler 30 acts as a placeholder for all of jobs submitted by a user. When submitted, the job scheduler informs the job manager 26 and the resource status manager 28 what to do, when to run the jobs, and where to run the jobs.

The job manager 26 can dispatch a job, e.g., a DNA sequence analysis, to the available nodes 32a, . . . , based on information provided by a resource mapping table and collect the results after a successful execution. Resource mapping tables can be built using multiple mapping techniques.

Mapping techniques can be static mapping and dynamic mapping. Static mapping means assigning processes to nodes at the compile time, while in dynamic mapping the tasks are assigned to the nodes at run time and they may be reassigned while they are running. Although the principal advantage of the static mapping is its simplicity, it fails to adjust to changes in the system state. Dynamic mapping takes into consideration the state of the system (workload, queue lengths, etc.) and makes use of real-time information. In general, the heuristics for dynamic mapping can be grouped into two categories: on-line (immediate) mode and batch-mode heuristics. In the on-line mode, a task is mapped onto a machine as soon as it arrives at the job scheduler. While in the batch mode, tasks are collected into a set that is examined for mapping at prescheduled times called mapping events.

The resource status manager 28 receives job submission requests, executes the requests on the nodes 32a, . . . , and can monitor the nodes 32a, . . . before, during and after the execution. Additionally, using information provided by the resource mapping table, the resource status manager 28 maintains the hardware topology information for the system, e.g., number of nodes, number of CPUs per node and number of cores per CPU.

An RMS manages, controls and maintains the status information of resources in a cluster system, e.g., processors and disk storage. Jobs submitted by the users 34a, . . . , into the cluster system are initially placed into queues until there are available nodes to execute the jobs. The RMS 20 also invokes the job scheduler 30 to determine how the nodes are assigned to various jobs. The RMS 20 further dispatches the jobs to the assigned nodes 32a, . . . , and manages the job execution processes before returning the results to the users 34a, . . . , upon job completion.

In cluster computing, the producer is the owner of the cluster system that provides and manages resources to accomplish users' service requests. The consumer is the user of the resources provided by the cluster system and can be either a physical human user or a software agent that represents a human user and acts on his behalf. A cluster system has multiple consumers submitting job requests that need to be executed. Mapping and scheduling of tasks in cluster computing systems are complex computational problems. Solving a mapping problem is basically deciding on which task should be moved to where and when, to improve the overall performance. There are a wide variety of approaches to the problem of mapping and scheduling in cluster computing systems.

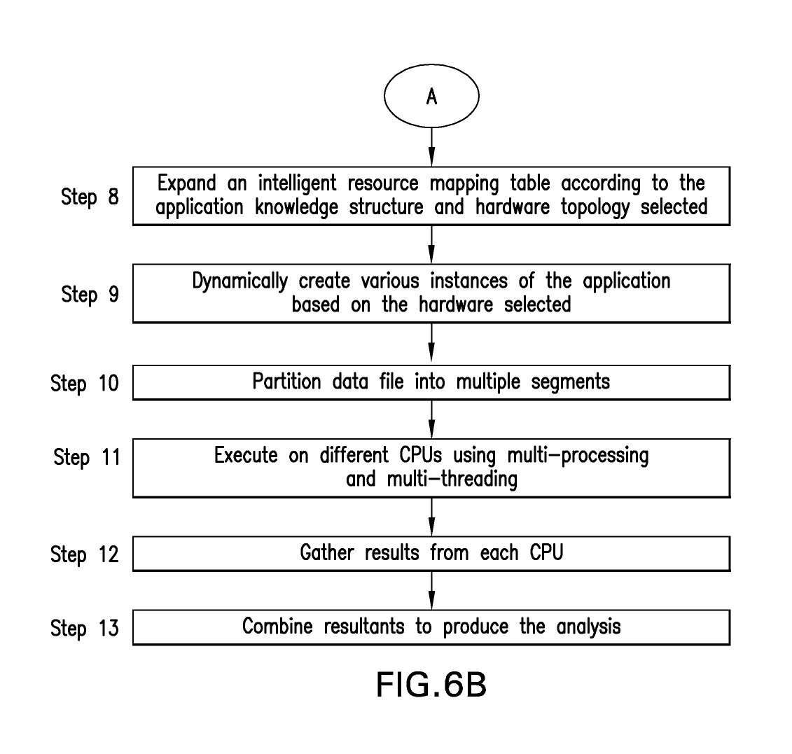

As shown in FIG. 5, an Intelligent Resource Management System (IRMS) 40 has three functional components that can be added into a traditional workload management system. The IRMS 40 can further include (1) an Application Knowledge Structure Module 43 (AKSM) that can be a part of a job scheduler 42, (2) an Intelligent Resource Mapping Table Module 49 (IRMTM) that can be a part of job manager 48 and (3) a Resource Management Table Module 46 (RMTM) that can be a part of a resource status monitor 44.

The AKSM 43 can create a dynamic and disjoint argument set using a hybrid model of: data-parallelization with multi-processing and multi-threading. In use, the AKSM 43 is capable of separating a job script file submitted by a consumer, e.g., job script files can be separated into application information and resource information. The AKSM can also validate an application's resource information (e.g. number of threads to run) to a user's requested resource requirement (e.g. number of cores required to run the application). Further, the AKSM 43 can build an application knowledge structure (AKS) and calculate the data segment size for data-parallelization. The data segment size equal to total number of reads in the data file (input file) divided by M, where M is number of CPUs needed to perform an analysis.

The IRMTM 49 is capable of invoking a call signature from the AKS and from this call signature build an intelligent resource mapping table (IRMT). The IRMT may contain M independent disjoint sets of an expanded application knowledge structure for multi-processing. (e.g., M instance of applications, M disjoint set of data segments (input files), P threads, etc.), where M is number of CPUs and P is number of cores per CPU. The IRMTM 49 can also submit M independent instances (e.g. job 53a) of the applications concurrently to every CPU and run P-number of multi-threads within a CPU. After successful execution of the applications, the partial results 54a obtained from every CPU can be merged into a single file in the same order of data segment distribution. The final execution results 52 (merged results) can be sent from job manager 48 to the user.

The RMTM 46 identifies suitable hardware resources to schedule the job 51 based on user 50a resource requirement. Hardware topology details can be collected from resource management table (RMT), e.g. N=16, M=4,P=4.

These modifications to the “job scheduler”, the “resource status monitor” and the “job manager” allow the Intelligent Resource Management System (IRMS) to achieve enhanced performance of a designated application at runtime. In other words, the IRMS creates an architecture-aware programming model for job submission by distributing the disjoint data segments of the data file(s) (input files) across the multiple CPUs using a optimal resource allocation and dynamic hardware topology. Hence, the data-parallelization with multi-processing (concurrent parallelization) with multi-threading is achieved at runtime for better performance without any manual performance engineering. Moreover, this architecture-aware programming model may not require source code modification.

In one implementation, the resource status manager can get the hardware topology information from the resource management table, where (i) N=total number of cores per node (ii) M=number of CPUs per node and (iii) P=number of cores per CPU. Once received, the job scheduler can partition a user-provided data file (input file) into independent data segments (chunks), where the number of data segments is equal to the number of CPUs in the node, the number of read lines in the data segments is equal to the total number of read lines divide by the number of CPUs in the node, i.e., number of reads in data segment 1+number of reads in data segment 2+ . . . number of reads in data segment M is equal to total number of read lines in the user-provided data (input) file. Further, the job schedule will ensure the data segment partition may not contain a partial read line (e.g. half of read line in one data segment and another half of read line in next data segment) and hence, the number of read lines in all the data segments are equal or almost equal to each others (i.e. if the read lines are not equally divisible amongst the CPUs, some CPUs will carry a remainder read lines). In other words, the number of reads in the data segments should be an integer and all the data segments are equal number of reads only when the divisible result is an integer (not a fractional number) so that all the data segments are an approximately equal number of reads and the sum of number of reads in all the data segments should be equal to the number of reads in the data file.

Next, M number of instances of sequence alignment application can be created and the independent (disjoint) data segments of the input file can be distributed to every instance of the application, e.g., first instance of the application uses first data segment, second instance of the application uses second data segment and so on.

The job manager then dispatches M instances of the sequence alignment application along with independent (disjoint) data segments of the input file to M CPUs. Additionally, every instance of the application runs with P threads, e.g., first instance of the application uses first data segment of the input file run on 1st CPU with P threads. Every instance of the application produces the partial results. All these partial results are merged (in the same order of partitioning) to obtain the final result.

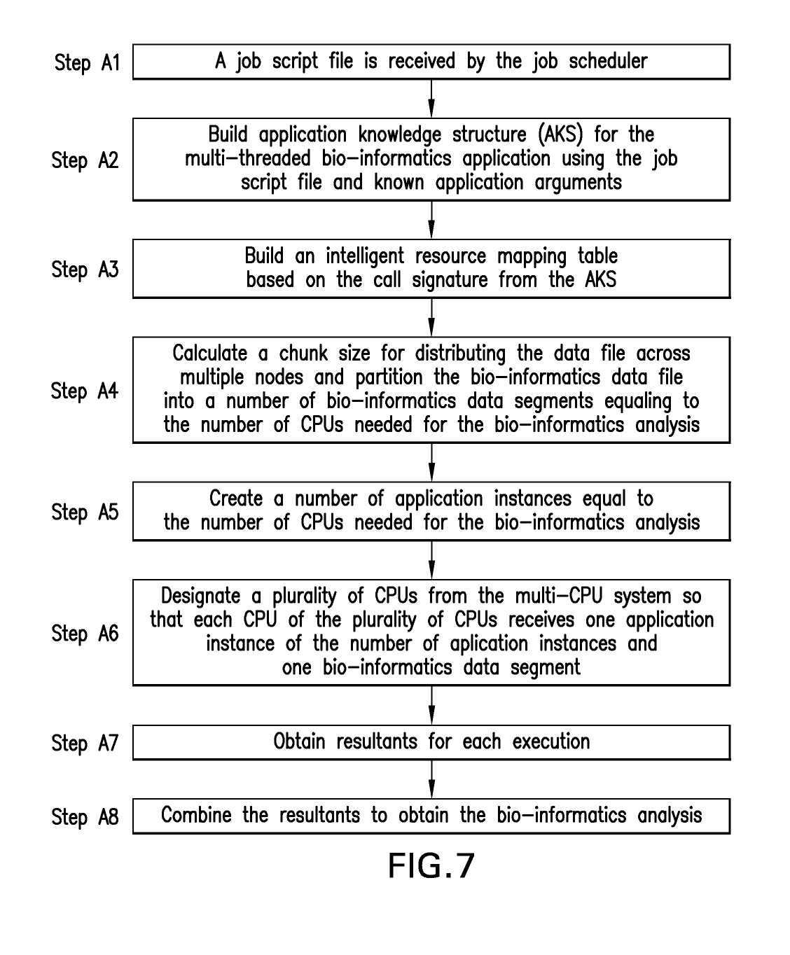

In another implementation, as shown in FIGS. 6A-B, a user can submit a job request designating resource requirements and applications needed for the analysis with the required input files. (Step 1). The IRMS can separate the application requirements and resource requirements (Step 2), and validate the application required resource list (e.g. number of threads required to run) to the user requested resource requirement (e.g. number of cores requested for scheduling the user-job within a node) (Step 3). If this matches, then the disclosed technology can proceed to the hybrid model for application performance improvement at runtime (Step 4). Otherwise, use the default scheduling technique (Step 4a).

To improve the application performance at runtime, the IRMS identifies the suitable resources for running the job (Step 5), collects the hardware topology details from the resource management table (Step 6), builds an application knowledge structure (AKS) using known application characteristics and their resource requirements (Step 7) and expands the intelligent resource mapping table (IRMT) according to the application knowledge structure and hardware topology selected (Step 8). The IRMT then dynamically creates various instances of the application based on the hardware selected (i.e., the number of CPUs) (Step 9).

Additionally, the IRMS partitions a data file into multiple data segments (Step 10) that are then executed on different CPUs by multi-processing (Step 11). Each CPU uses a multi-threading technique to run the application on multiple cores within the CPU. The results for each CPU can be gathered (Step 12) and these resultants can be combined to produce the analysis (Step 13).

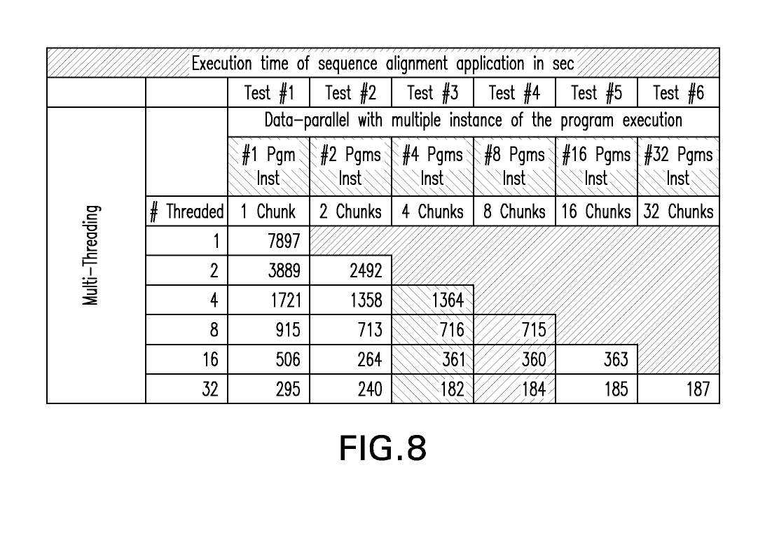

In another implementation, shown in FIG. 7, a job script file is received by the job scheduler (Step A1). The job script file can request to run a bio-informatics analysis for a bio-informatics data file on a multi-CPU system using a multi-threaded bio-informatics application. The job script file can include an application to be used for the job, its argument details and its resource requirements, e.g., the job script file identifies the application to run, number of threads to run, input file(s) needed for the job, and any reference files. The job scheduler separates the application from its arguments details and user resource requirement. A check is run to determine if the number of cores requested by the user matches with number of application threads to run. If these conditions are satisfied, the IRMS is implemented; otherwise, the job is submitted using a default job submission method.

If the conditions are satisfied, the AKSM builds an application knowledge structure for the multi-threaded bio-informatics application using the job script file and known application arguments (Step A2). The application knowledge structure can have a dynamic and disjoint set of arguments that can be independently executable at each CPU of the multi-CPU system.

An intelligent resource mapping table is built based on a call signature from the AKS (Step A3). The intelligent resource mapping table can request a number of CPUs needed to perform the bio-informatics analysis.

The job scheduler calculates a data segment size for distributing the data file across multiple nodes and partitions the bio-informatics data file into a number of bio-informatics data segments equaling to the number of CPUs needed for the bio-informatics analysis (Step A4). The AKS creates a number of application instances equal to the number of CPUs needed for the bio-informatics analysis (Step A5).

At the resource status manager, the resource status manager designates a plurality of CPUs from the multi-CPU system so that each CPU of the plurality of CPUs receives one application instance of the number of application instances and one bio-informatics data segment of the number of bio-informatics data segments with the plurality of CPUs equaling the number of CPUs needed for the bio-informatics analysis. (Step A6). Once the suitable hardware is identified, the hardware topology details can be collected from the scheduler's resource management table, where: N is the required number of cores to run the job, M is the number of CPUs (where, N≧M) and P is the number of cores per CPU (Where, P≧M and N=P*M). The AKS distributes the various arguments to build the Intelligent Resource Mapping Table (IRMT). Every entry submitted to the CPU contains the expanded application knowledge structure. For example, the IRMT can have M instances of the application with independent disjoint set of data segments (input file) so that the IRMT is executed locally at every CPU.

For example, the job manager can submit M instances of the application concurrently to every CPUs needed for bio-informatics analysis. A plurality of CPUs from the multi-CPU system can be designated so that each CPU of the plurality of CPUs receives one application instance of the number of application instances and one bio-informatics data segment of the number of bio-informatics data segments. The multi-threaded bio-informatics for each bio-informatics data segment on each CPU of the plurality of CPU can be executed, wherein the bio-informatics multi-process for each bio-informatics data segment is executed within a number of cores associated with each CPU of the plurality of CPUs. Hence, data-parallelization and multi-processing is defined across all the CPUs. At the same time, multiple threads are executed within the CPU. Hence, data-parallelization with multi-processing and multi-threads can be implemented without any source code modification.

After the successful execution, resultants for each execution of the multi-process on each CPU of the plurality of CPUs are obtained (Step A7). The resultants are combined in the same order of data partitioning to obtain the bio-informatics analysis (Step A8). The job manager can send the merged result to the user.

The IRMS eliminates the drawbacks of the conventional RMS. Moreover, the multi-process execution across the CPUs, dynamic data distribution based on the hardware selection, supported by multiple usage scenarios (multi-processing with multithreading), architecture-aware optimizations and dynamic resource utilization are some of the implementation mechanisms at runtime that can be run without any manual performance engineering concepts and source code modifications.

### EXAMPLE 1

A user job script file is submitted to the job scheduler. The job scheduler separates resource information from the application information and identifies the application information details, e.g. program name and number of application threads. If the number of application threads matches with the number of cores required, the intelligent scheduling is invoked. The AKS with dynamic arguments is built and the data segment size of the input file is calculated.

The resource status monitor then ensures that the job is run at N number of cores system, M number of CPUs per node and every CPU has P number of cores using the hardware topology information, e.g., N=16, M=4 and P=4.

The Intelligent Resource Mapping Table (IRMT) is built by the job manager and every CPU entry contains the expanded application knowledge structure. The job manager dispatches M instances of jobs to every CPU. Partial results are collected from every CPU and merge together (in the same order of distribution) to get the final result. This final result can be sent to the user.

In another implementation, a sequence alignment application may be utilized. A sequence alignment is the process of arranging the sequences of DNA, RNA, or protein to identify regions of similarity or dissimilarity relationships between the sequences. There are various sequence alignment algorithms, software tools, application packages and web-based platforms used in pairwise and multi-sequence alignments. Most of these sequence alignment applications are based on a multi-threaded paradigm, which can be run on desktop machine, multicore system, cloud environment or high performance computing (HPC) systems.

To increase performance of a sequence alignment application, the bio-information can follow conventional multi-step performance engineering concepts: (1) Scalability study: Run the application with 1,2,4 . . . T threads based on the available number of cores N (total number of cores within a node) in system; (2) Performance profile: Get the application performance profile and debug the performance bottleneck, which may be due to thread contention, limitations in shared cache size while increasing number of threads, possibility of cache coherence problem, multi-thread synchronization issues, time delay due to remote memory access etc.; and (3) Optimal selection: Based on the above scalability study and performance profile results, the bio-information can select the optimal thread size-T (where, N≧T≧1).

As a result, the application can improve performance while using T-threads on the particular hardware. The above approach required N times to run the application to select the optimal thread size-T. Additionally, the architecture aware optimizations (e.g., hybrid programming models for Multi-CPU nodes, eliminate remote memory access for NUMA architecture, etc.), compiler optimizations, architecture aware algorithm development are various optimization techniques that can be carried out as a part of the disclosed technology.

The technique proposed here may not require the above multi-step performance engineering concepts to get the best application optimization. Additionally, the bio-information may not require understanding the algorithm implementation details, application runtime options like thread-parallel or data parallelization techniques to enhance the performance of the sequence alignment. Since some schedulers support architecture awareness features, the user submitted jobs can be modified into appropriate parallel programming paradigm (e.g. hybrid programming) and the performance can be improved at run-time without any multi-step performance engineering concepts.

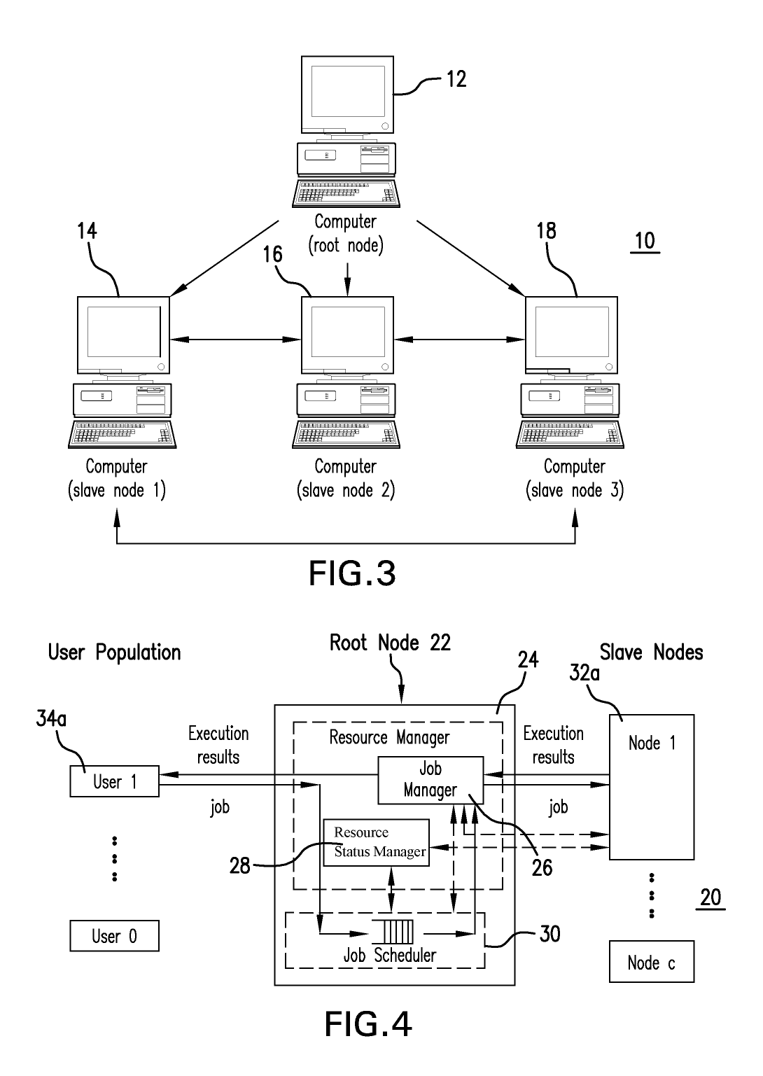

The IRMT triggers four copies of sequence alignment programs with four data segments to every CPU. The job manager can submit the four copies of the applications instances to four CPUs. Every CPU can run single application instance with a single disjoint data segment and four threads as multi-threading, totaling 16 application threads. As a result, different independent data segments are executing across all the CPUs and hence the uniform resource allocation is observed as illustrated in FIG. 2.

Experiment #1:

The following test cases (from Test #1 to Test #6) were conducted on a single node server that has 4 CPUs, 8 cores per CPU totaling 32 cores. The time taken to partition the input file into multiple data segments (multiple chunks) and time taken to merge the final resultant from the various instance of the programs are given.

Test #1: Baseline Test

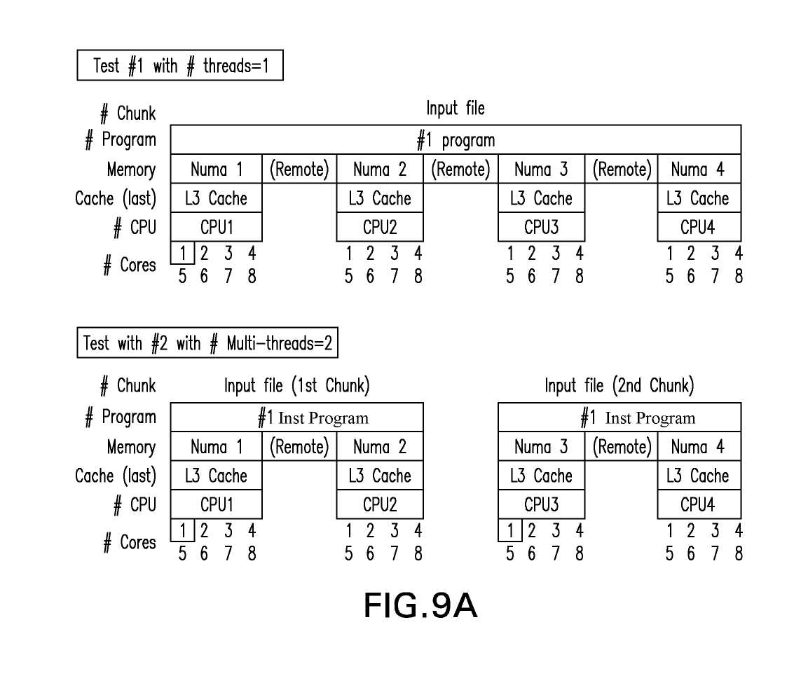

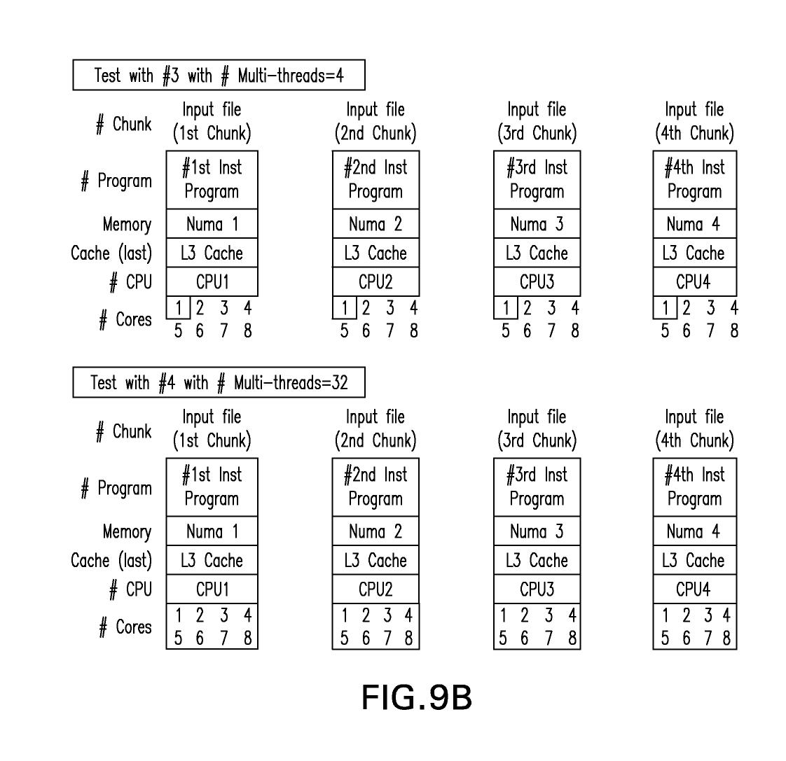

Traditional thread scalability numbers (Refer: Test #1 results in FIG. 8) are used as baseline performance results. Here, (i) the data file (input file) used “as-is” without partition (ii) executed the program with threads=1,2,4,8,16 and 32 and tabulated the results, see FIG. 8 in Test #1 column. The experimental illustration of the program execution with threads=1 is shown in FIG. 9 (Test #1 with #threads=1).

Data-parallelization with multi-processing and multi-threading test were conducted (Test #2 to Test #6):

Test #2:

(i) partition input file(s) into two approximately equal data segments (i.e. 2 chunks) (ii) execute two instance (i.e. 2 program instances) of the application with: Multi- threads=2 (1 thread each for every instance, i.e., 1 thread×2 instance), Multi-threads=4 (2 threads each for every instance, i.e., 2 threads×2 instance), Multi-threads=8 (4 threads each for every instance, i.e., 4 threads×2 instance), Multi-threads=16 (8 threads each for every instance, i.e., 8 threads×2 instance) and Multi-threads=32 (16 threads each for every instance, i.e., 16 threads×2 instance). The results are tabulated; in FIG. 8, Test #2 column. The experimental illustration of the #2 program instances execution with Multi-threads=2 is shown in FIG. 9 (Test #2 with #Multi-threads=2).

Test #3:

(i) partition input file(s) into four approximately equal data segments (i.e., 4 chunks) (ii) execute four instance of the application with: Multi- threads=4 (1 thread each for every instance, i.e. 1 thread×4 instance), Multi-threads=8 (2 threads each for every instance, i.e. 2 threads×4 instance), Multi-threads=16 (4 threads each for every instance, i.e. 4 threads×4 instance) and Multi-threads=32 (8 threads each for every instance, i.e. 8 threads×4 instance). The results are tabulated in FIG. 8, Test #3 column. The experimental illustration of the #4 program instances execution with Multi-threads=4 is shown in FIG. 9 (Test #3 with #Multi-threads=4).

Test #4:

(i) partition input file(s) into eight approximately equal data segments (i.e., 8 chunks) (ii) execute eight instance of the application with: Multi- threads=8 (1 thread each for every instance, i.e. 1 thread×8 instance), Multi-threads=16 (2 threads each for every instance, i.e. 2 threads×8 instance) and Multi-threads=32 (4 threads each for every instance, i.e. 4 threads×8 instance). The results are tabulated in FIG. 8, Test #4 column.

Test #5:

(i) partition input file(s) into sixteen approximately equal data segments (i.e. 16 chunks) (ii) execute sixteen instance of the application with: Multi-threads=16 (1 threads each for every instance, i.e. 1 threads×16 instance) and Multi-threads=32 (2 threads each for every instance, i.e. 2 threads×16 instance). The results are tabulated in FIG. 8 in Test #5 column.

Test #6:

(i) partition input file(s) into thirty-two approximately equal data segments (i.e., 32 chunks) (ii) execute thirty-two instance of the application with: Multi-threads=32 (1 thread each for every instance, i.e. 1 thread×32 instance). The results are tabulated in FIG. 8, Test #6 column.

Optimized Results: within every CPU, 8 threads were run (4 instances of application×8 multi-threads, totaling 32 application threads) and as a result, 38% performance improvement was achieved compared with baseline performance results; (See the performance difference between FIG. 8 in Test #3 column (optimized results) and FIG. 8 in Test #1 (baseline results) column). The disclosed technology identifies the target architecture as 4 CPUs per node and 8 cores per CPU. Hence, the user provided data file (input file) was partitioned into 4 data segments. The disjoint data segment was distributed into each CPUs and four instances of the application were run with 8 multi-threads. As a result in this experiment, the possibility of performance improvement is 38% at runtime without any performance-engineering steps (Test #1 to Test #7) and source code modifications. The experimental illustration of the #4 program instances execution with Multi-threads=32 is shown in FIG. 9 (Test #3 with #Multi-threads=32).

Experiment #2

The following test cases (from Test #1 to Test #7) were conducted (as part of performance engineering concept) on single node server that has 8 CPUs, 8 cores per CPU totaling 64 cores.

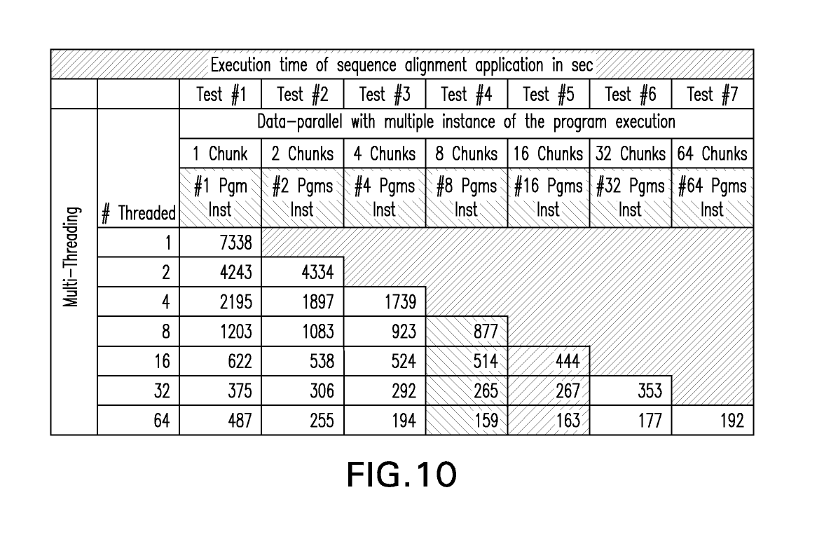

The experiment was conducted on 8 CPUs, 8 cores per CPU, totaling 64 cores server. The traditional thread scalability numbers (Refer: Test #1 results in FIG. 10) are used as baseline performance results. As part of performance engineering concept, Test #2 to Test #7 results were conducted as a hybrid-concept: data-parallel with multi-processing and multi-threading. Test #2 results uses, the data file (input file) partition into two approximately equal data segments (i.e. 2 chunks) and executes two instances (i.e. 2 program instances) of the application with: Multi-threads=2 (1 thread each for every instance, i.e. 1 thread×2 instance), Multi-threads=4 (2 threads each for every instance, i.e. 2 threads×2 instance), Multi-threads=8 (4 threads each for every instance, i.e. 4 threads×2 instance), Multi-threads=16 (8 threads each for every instance, i.e. 8 threads×2 instance), Multi-threads=32 (16 threads each for every instance, i.e. 16 threads×2 instance) and Multi-threads=64 (32 threads each for every instance, i.e., 32 threads×2 instance). The results are tabulated in FIG. 10, Test #2 column. Similarly, the various experiments (Test #3 to Test#7) were conducted and results tabulated in FIG. 10 for complete summary of results. A 67% performance improvement was observed when 8 instances of the application uses 8 disjoint set of data segments run with 8 multi-threads (Refer: Test #4 with 64 threads results in FIG. 10).

The disclosed technology identifies the architecture has 8 CPUs per node and 8 cores per CPU. Hence, the user-provided data file (input file) can be partitioned into 8 pieces (i.e., 8 data segments) and can distribute them across the CPUs by using 8 instances of the application. Within every CPU, 8 threads (8 instances of application×8 multi-threads, totaling 64 application threads) were run and as a result, a 67% performance improvement was observed at runtime without any performance engineering concepts. From the above (Experiment #1 and Experiment #2 are from different architectures), it is demonstrated that, the disclosed technology partitions the data file (input file) into a disjoint set of data segments, which are equal to the number of CPUs available in the target architecture, runs the application into multiple instance (equal to number of CPUs) with multi-threads (equal to the number of cores per CPUs) and improves the performance of the CPUs and applications at run time without any manual performance optimizations. Hence, this disclosed technology implements data-parallel with multi-processing and multi-threading at runtime without any source code modifications.

Advantages of the disclosed technology is that the technology (1) uses architecture intelligence to bring better performance to the CPUs and applications at runtime, (2) automates the architecture based performance engineering at the scheduler before job submission, (3) dynamically does all the steps at runtime at the scheduler without manual process, (4) has a uniform resource allocation that eliminates remote memory access, (5) minimizes cache misses, (6) creates a dynamic process and (7) improves the performance optimally at runtime.

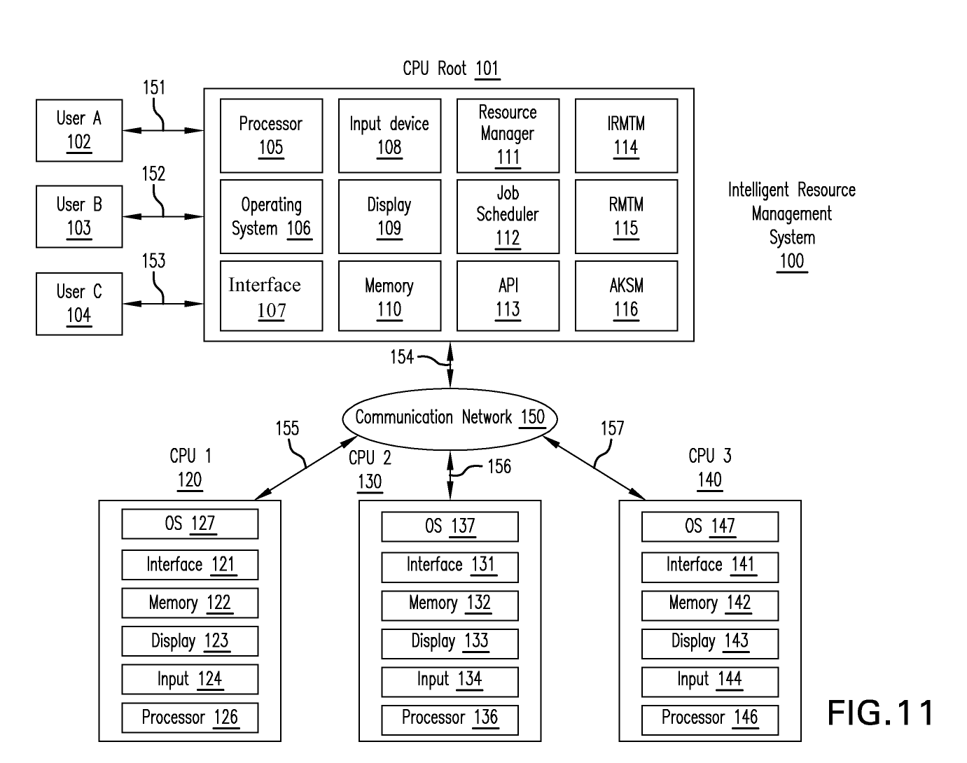

FIG. 11 is a schematic diagram of an example of an intelligent resource management system 100. The system 100 includes one or more processors 105, 126, 136, 146, one or more display devices 109, 123, 133, 143, e.g., CRT, LCD, one or more interfaces 107, 121, 131, 141, input devices 108,124, 134, 144, e.g., touchscreen, keyboard, mouse, scanner, etc., and one or more computer-readable mediums 110, 122, 132, 142. These components exchange communications and data using one or more buses 154-157, e.g., EISA, PCI, PCI Express, etc. The term “computer-readable medium” refers to any non-transitory medium that participates in providing instructions to processors 105, 126, 136, 146 for execution. The computer-readable mediums further include operating systems 106, 127, 137, 147.

The operating systems 106, 127, 137, 147can be multi-user, multiprocessing, multitasking, multithreading, real-time, near real-time and the like. The operating systems 106, 127, 137, 147 can perform basic tasks, including but not limited to: recognizing input from input devices 108, 124, 134, 144; sending output to display devices 109, 123, 133, 143; keeping track of files and directories on computer-readable mediums 110, 122, 132, 142, e.g., memory or a storage device; controlling peripheral devices, e.g., disk drives, printers, etc.; and managing traffic on the one or more buses 151-157. The operating systems 106, 127, 137, 147 can also run algorithms associated with the system 100 and, in some implementations, the operating systems will all run the same operating system e.g. all CPUs will operate Red Hat Enterprise Linux 6.5.

The network communications code can include various components for establishing and maintaining network connections, e.g., software for implementing communication protocols, e.g., TCP/IP, HTTP, Ethernet, etc.

Moreover, as can be appreciated, in some implementations, the system 100 of FIG. 11 is split into a root-slave environment 101, 120, 130, 140 communicatively connected with connectors 154-157, where one or more root computers 101 include hardware as shown in FIG. 11 and also code for managing the resources of the computer network and where one or more slave computers 120, 130, 140 include hardware as shown in FIG. 11.

Implementations of the subject matter and the operations described in this specification can be done in electronic circuitry, or in computer software, firmware, or hardware, including the structures disclosed in this specification and their structural equivalents, or in combinations of one or more of them. Implementations of the subject matter described in this specification can be done as one or more computer programs, e.g., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or can be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer comprise a processor for performing or executing instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, thought or tactile input. In addition, a computer can interact with a user by sending documents to and receiving documents from a device that is used by the user.

While this specification contains many specific implementation details, these should not be construed as limitations on the scope of the disclosed technology or of what can be claimed, but rather as descriptions of features specific to particular implementations of the disclosed technology. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. In some cases, the actions recited in the claims can be performed in a different order and still achieve desirable results. Moreover, the separation of various system components in the implementations described above should not be understood as requiring such separation in all implementations, and it should be understood that the described program components and systems can generally be integrated together in a single software product or packaged into multiple software products.

The foregoing Detailed Description is to be understood as being in every respect illustrative, but not restrictive, and the scope of the disclosed technology disclosed herein is not to be determined from the Detailed Description, but rather from the claims as interpreted according to the full breadth permitted by the patent laws. It is to be understood that the implementations shown and described herein are only illustrative of the principles of the disclosed technology and that various modifications can be implemented without departing from the scope and spirit of the disclosed technology.

1. A method comprising the steps of:
receiving a job script file, the job script file requesting to run an analysis for a data filed on a multi-CPU system using a multi-threaded application;
building an application knowledge structure for the multi-threaded application from the job script file and known application arguments, the application knowledge structure having a dynamic and disjoint set of arguments that can be independently executable at each CPU of the multi-CPU system;
building an intelligent resource mapping table based on the application knowledge structure, the intelligent resource mapping table requesting a number of CPUs needed for the analysis;
partitioning the data file into a number of data segments equaling to the number of CPUs needed for the analysis;
creating a number of application instances equal to the number of CPUs needed for the analysis;
designating a plurality of CPUs from the multi-CPU system so that each CPU of the plurality of CPUs receives one application instance of the number of application instances and one data segment of the number of data segments, the plurality of CPUs equaling the number of CPUs needed for the analysis;
executing the multi-threaded applications for each data segment on each CPU of the plurality of CPUs, wherein a multi-process is executed for each data segment within a number of CPU cores associated with each CPU of the plurality of CPUs; and
obtaining resultants for each execution of the multi-process on each CPU of the plurality of CPUs.

2. The method of claim 1 further comprising the steps of:
combining the resultants in the same order of data partitioning to obtain the analysis.

3. The method of claim 1 wherein the executing step uses a hybrid model of data-parallel, multi-process and multi-threads and is dynamically implemented at runtime to improve application performance.

4. The method of claim 1 wherein the application can run as multi-threads equaling a number of cores for each CPU running different data segments.

5. The method of claim 1 further comprising the steps of:
separating the job script file into application information and resource information.

6. The method of claim 1 further comprising the steps of:
validating application required resource information against hardware resource requested information of the job script file; and
if the application resource required information matches with the hardware resource requested information of the job script file, identifying hardware resources associated with the multi-CPU system for scheduling the request.

7. The method of claim 6 wherein based on the identified resources, hardware topology details can be collected from the intelligent resource management table.

8. The method of claim 1 wherein the analysis is a sequence alignment and the data file is a sequence alignment file.

9. The method of claim 1 wherein the data segments are approximately equal to the total number of reads in the data file divided by the number of CPUs needed for the analysis.

10. The method of claim 1 wherein the application information includes application name, reference data, input files and number of threads to run.

11. A system comprising:
one or more processors;
one or more computer-readable storage mediums containing instructions configured to cause the one or more processors to perform operations including:
receiving a job script file, the job script file requesting to run an analysis for a data file on a multi-CPU system using a multi-threaded application;
building an application knowledge structure for the multi-threaded application from the job script file and known application arguments, the application knowledge structure having a dynamic and disjoint set of arguments that can be independently executable at each CPU of the multi-CPU system;
building an intelligent resource mapping table based on the application knowledge structure, the intelligent resource mapping table requesting a number of CPUs needed for the analysis;
partitioning the data file into a number data segments equaling to the number of CPUs needed for the analysis;
creating a number of application instances equal to the number of CPUs needed for the analysis;
designating a plurality of CPUs from the multi-CPU system so that each CPU of the plurality of CPUs receives one application instance of the number of application instances and one data segment of the number of data segments, the plurality of CPUs equaling the number of CPUs needed for the analysis;
executing the multi-threaded applications for each data segment on each CPU of the plurality of CPUs, wherein a multi-process is executed for each data segment within a number of CPU cores associated with each CPU of the plurality of CPUs;
obtaining resultants for each execution of the multi-process on each CPU of the plurality of CPUs.

12. The system of claim 11 further comprising the steps of:
combining the resultants in the same order of data partitioning to obtain the analysis.

13. The system of claim 11 wherein the executing step uses a hybrid model of data-parallel, multi-process and multi-threads and is dynamically implemented at runtime to improve application performance.

14. The system of claim 11 wherein the application can run as multi-threads equaling a number of cores for each CPU running different data segments.

15. The system of claim 11 further comprising the steps of:
separating the job script file into application information and resource information.

16. The system of claim 11 further comprising the steps of:
validating application resource required information against hardware resource required information of the job script file; and
if the application resource required information matches with the hardware resource requested information of the job script file, identifying hardware resources associated with the multi-CPU system for scheduling the request.

17. The system of claim 16 wherein based on the identified resources, hardware topology details can be collected from the intelligent resource management table.

18. The system of claim 11 wherein the analysis is a sequence alignment and the data file is a sequence alignment file.

19. The system of claim 11 wherein the data segments are approximately equal to the total number of reads in the data file divided by the number of CPUs needed for the analysis.

20. The system of claim 11 wherein the application information includes application name, reference data, input files and number of threads to run.

21. A system comprising:
a processor that receives a job script file, the job script file requesting to run an analysis for a data file on a multi-CPU system using a multi-threaded application;
a processor that builds an application knowledge structure for the multi-threaded application from the job script file and known application arguments, the application knowledge structure having a dynamic and disjoint set of arguments that can be independently executable at each CPU of the multi-CPU system;
a processor that builds an intelligent resource mapping table based on the application knowledge structure, the intelligent resource mapping table requesting a number of CPUs needed for the analysis;
a processor that partitions the data file into a number of data segments equaling to the number of CPUs needed for the analysis;
a processor that creates a number of application instances equal to the number of CPUs needed for the analysis;
a processor that designates a plurality of CPUs from the multi-CPU system so that each CPU of the plurality of CPUs receives one application instance of the number of application instances and one data segment of the number of data segments, the plurality of CPUs equaling the number of CPUs needed for the analysis;
a processor that executes the multi-threaded applications for each data segment on each CPU of the plurality of CPUs, wherein a multi-process is executed for each data segment within a number of CPU cores associated with each CPU of the plurality of CPUs; and
a processor that obtains resultants for each execution of the multi-process on each CPU of the plurality of CPUs.

22. A system comprising:
a processor that receives a job script file, the job script file requesting to run an analysis for a data file on a multi-CPU system using a multi-threaded application;
the processor builds an application knowledge structure for the multi-threaded application from the job script file and known application arguments, the application knowledge structure having a dynamic and disjoint set of arguments that can be independently executable at each CPU of the multi-CPU system;
the processor builds an intelligent resource mapping table based on the application knowledge structure, the intelligent resource mapping table requesting a number of CPUs needed for the analysis;
the processor partitions the data file into a number of data segments equaling to the number of CPUs needed for the analysis;
the processor creates a number of application instances equal to the number of CPUs needed for the analysis;
the processor designates a plurality of CPUs from the multi-CPU system so that each CPU of the plurality of CPUs receives one application instance of the number of application instances and one data segment of the number of data segments, the plurality of CPUs equaling the number of CPUs needed for the analysis;
the processor executes the multi-threaded applications for each data segment on each CPU of the plurality of CPUs, wherein a multi-process is executed for each data segment within a number of CPU cores associated with each CPU of the plurality of CPUs; and
the processor obtains resultants for each execution of the multi-process on each CPU of the plurality of CPUs.

23. A resource manager run on a multi-CPU system using a multi-threaded application comprising:
an application knowledge structure, stored in a non-transitory medium, having a dynamic and disjoint set of arguments that can be independently executable at each CPU of the multi-CPU system, the application knowledge structure being built from a job script file requesting to run an analysis for a data file and known application arguments for the multi-threaded application;
an intelligent resource mapping table, stored in a non-transitory medium, requesting a number of CPUs needed for the analysis, the intelligent resource mapping table being built based on the application knowledge structure; and
a processor that partitions the data file into a number data segments equaling to the number of CPUs needed for the analysis, creates a number of application instances equal to the number of CPUs needed for the analysis, designates a plurality of CPUs from the multi-CPU system so that each CPU of the plurality of CPUs receives one application instance of the number of application instances and one data segment of the number of data segments, the plurality of CPUs equaling the number of CPUs needed for the analysis, executes the multi-threaded applications for each data segment on each CPU of the plurality of CPUs, wherein a multi-process is executed for each data segment within a number of CPU cores associated with each CPU of the plurality of CPUs and obtains resultants for each execution of the multi-process on each CPU of the plurality of CPUs.
